(19) United States
(12) Patent Application Publication
(10) Pub. No.: US 2025/0246383 A1
(43) Pub. Date: Jul. 31, 2025

(54) INTERRUPTER WITH INVERTED CONFIGURATION AND SELF-UNLATCHING MECHANISM

(71) Applicant: S&C Electric Company, Chicago, IL (US)

(72) Inventors: Leo Caro, Chicago, IL (US); Thomas J. Dyer, Minneola, FL (US); Richard Mikosz, Hickory Hills, IL (US); Goran Djogo, Mount Prospect, IL (US)

(73) Assignee: S&C Electric Company, Chicago, IL (US)

(21) Appl. No.: 19/038,049

(22) Filed: Jan. 27, 2025

Related U.S. Application Data
(60) Provisional application No. 63/626,335, filed on Jan. 29, 2024.

(51) Int. Cl. H01H 33/666; H01H 9/16; H01H 9/24; H01H 33/66

(52) U.S. Cl. CPC H01H 33/666; H01H 9/16; H01H 9/24; H01H 33/6606; H01H 2033/6667

(57) ABSTRACT

A cutout mounted switching device including a vacuum interrupter having a fixed terminal coupled to a lower coupling assembly and a movable terminal coupled to a drive rod. The switching device also includes an actuation assembly having a spring mechanism with a solenoid and a plunger, where the plunger is coupled to the drive rod. The actuation assembly further includes a dropout mechanism coupled to the plunger and having a dropout pin, where the dropout pin is coupled to a switch structure that is releasably coupled to the upper coupling assembly, and where the plunger and the dropout pin are axially offset relative to each other. The actuation assembly is configured to open and close the vacuum interrupter and cause the switching device to be released from the upper coupling assembly and rotate to a drop out position on the lower coupling assembly.

### CROSS-REFERENCE TO RELATED APPLICATION

This application claims the benefit of priority from the U.S. Provisional Application No. 63/626,335, filed on Jan. 29, 2024, the disclosure of which is hereby expressly incorporated herein by reference for all purposes.

### BACKGROUND

### Field

This disclosure relates generally to a cutout mounted switching device and, more particularly, to a cutout mounted fault interrupting switching device that includes an actuation assembly having a dropout mechanism at the top of the device and a vacuum interrupter at the bottom of the device.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three phase feeders including three single phase feeder lines that carry the same current, but are 120° apart in phase. three phase and single phase lateral lines are tapped off of the feeder that provide the medium voltage to various distribution transformers, where the voltage is stepped down to a low voltage and is provided to loads, such as homes, businesses, etc. Power distribution networks of the type referred to above typically include switching devices, breakers, reclosers, interrupters, etc. that control the flow of power throughout the network.

Periodically, faults occur in the distribution network because of various things, such as animals touching the lines, lightning strikes, tree branches falling on the lines, vehicle collisions with utility poles, etc. Faults may create a short-circuit that increases the stress on the network, which may cause the current flow to significantly increase, for example, many times above the normal current, along the fault path. This amount of current causes the electrical lines to significantly heat up and possibly melt, and also could cause mechanical damage to various components in the network. These faults are often transient or intermittent faults as opposed to a persistent or bolted fault, where the thing that caused the fault is removed a short time after the fault occurs, for example, a lightning strike. In such cases, the distribution network will almost immediately begin operating normally after a brief disconnection from the source of power.

Traditionally, a fuse is employed as a primary overload protection device for protecting distribution transformers and other devices that has a certain rating so that the fuse will operate above a transformer inrush current, but below a transformer through fault protection withstand or damage curve. However, fuses often create an arc and sparks when they operate, which has obvious dangers and drawbacks. Further, fuses need to be replaced after they operate.

It has become increasingly popular to replace the traditional fuse with a cutout mounted fault interrupting device that employs a vacuum interrupter and an actuator to operate the vacuum interrupter. A vacuum interrupter is a switch that employs opposing contacts, one fixed and one movable, positioned within a vacuum enclosure. When the vacuum interrupter is opened by operating the actuator to move the movable contact away from the fixed contact to prevent current flow through the interrupter a plasma arc is created between the contacts that is contained and quickly extinguished by the vacuum at the next zero current crossing. When fault current is detected by the device the vacuum interrupter is opened and the device is released or “drops out” of its mounting indicating that it has operated.

Efforts continue to improve the design of these types of cutout mounted fault interrupting devices to reduce cost, reduce complexity, increase reliability, etc.

### SUMMARY

The following discussion discloses and describes a cutout mounted switching device configured to be coupled to an upper coupling assembly on a utility pole and a lower coupling assembly on the utility pole. The switching device includes a vacuum interrupter having a fixed terminal electrically coupled to the lower coupling assembly and a movable terminal electrically coupled to a drive rod. The switching device also includes an actuation assembly having a spring mechanism with a solenoid and a plunger, where the plunger is coupled to the drive rod. The actuation assembly further includes a dropout mechanism coupled to the plunger and having a dropout pin, where the dropout pin is coupled to a switch structure that is releasably coupled to the upper coupling assembly, where the plunger and the dropout pin are axially offset relative to each other. The actuation assembly is configured to open and close the vacuum interrupter and cause the switching device to be released from the upper coupling assembly and rotate to a drop out position on the lower coupling assembly in response to overcurrent.

Additional features of the disclosure will become apparent from the following description and appended claims, taken in conjunction with the accompanying drawings.

### BRIEF DESCRIPTION OF THE DRAWINGS

FIG. 1 is a side view of a switch assembly connected to a pole mounted insulator and including a cutout mounted fault interrupting switching device;

FIG. 2 is a side view of the switch assembly shown in FIG. 1 with an outer housing removed from the switching device; and

FIG. 3 is a cut-away side view of a top portion of the switching device.

### DETAILED DESCRIPTION OF THE EMBODIMENTS

The following discussion of the embodiments of the disclosure directed to a cutout mounted fault interrupting switching device that includes an actuation assembly having a dropout mechanism at the top of the device and a vacuum interrupter at the bottom of the device is merely exemplary in nature, and is in no way intended to limit the disclosure or its applications or uses.

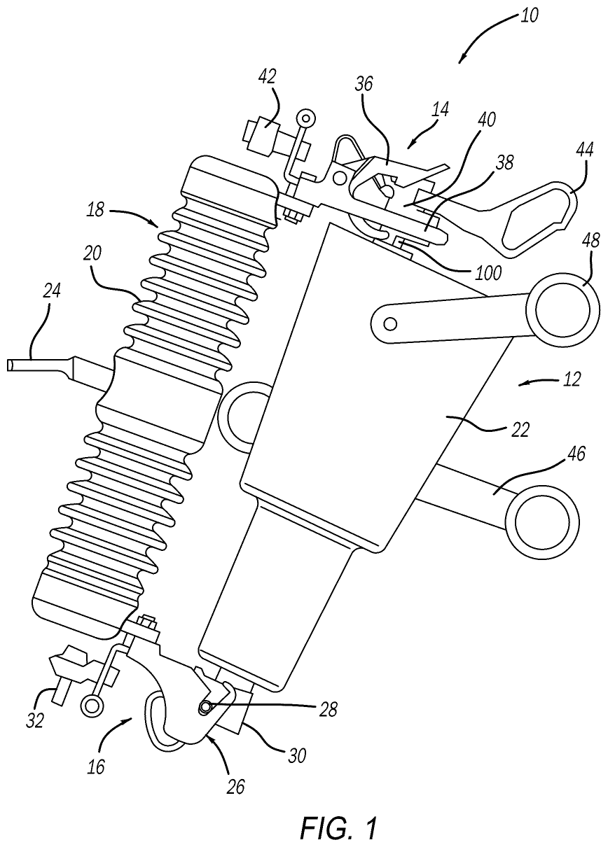

FIG. 1 is a side view of a pole mounted switch assembly 10 including a cutout mounted fault interrupting switching device 12 having an outer housing 22, where the switching device 12 is intended to represent any switching device suitable for the purposes discussed herein. The switching device 12 is coupled to an upper coupling assembly 14 at its top end and a lower coupling assembly 16 at its bottom end. The upper assembly 14 is secured to one end of an insulator 18 having skirts 20 and the lower assembly 16 is secured to an opposite end of the insulator 18, where the insulator 18 is mounted to a bracket 24 that may be attached to a utility pole (not shown). The lower assembly 16 includes a cutout hinge 26 that accepts a trunnion rod 28 on a trunnion assembly 30 coupled to the device 12 and that is electrically coupled to a bottom terminal 32. The upper assembly 14 includes components 36 and 38 that are configured to releasably hold a support structure 40 coupled to the housing 22, where the component 38 is coupled to a top terminal 42. A pull ring 44 is coupled to the structure 40 and allows a worker to remove the device 12 from the assemblies 14 and 16 by pulling on the ring 44 to disengage the structure 40 from the upper assembly 14, rotate the device 12 outward on the trunnion rod 28 and then lifting the device 12 out of the hinge 26. An open/close lever 46 allows the switching device 12 to be manually opened and closed and a charging lever 48 allows the switching device 12 to be manually charged. An alternative design could combine the charging lever 48 and the open/close lever 46. Various designs and configurations of cutout mounted switching devices that operate in this manner as described so far are well known by those skilled in the art.

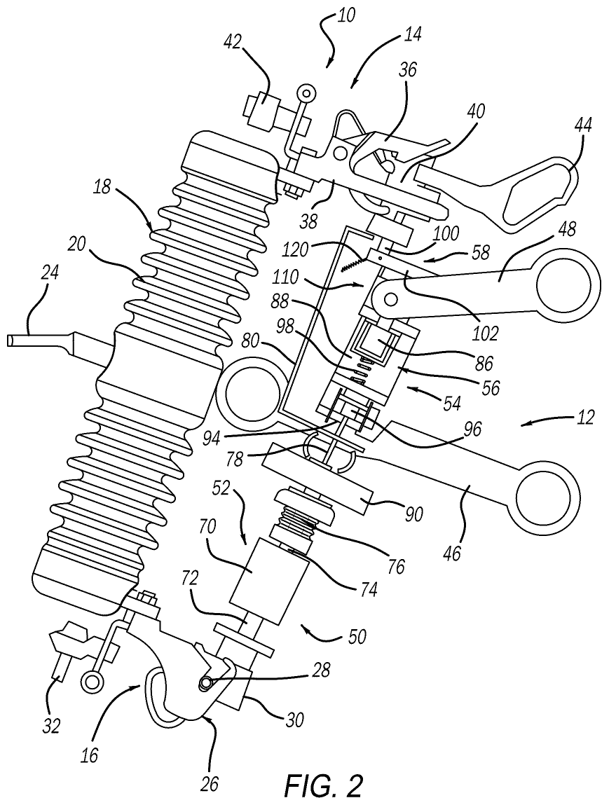

FIG. 2 is a side view of the switch assembly 10 with the outer housing 22 removed from the switching device 12 to show the various parts therein. The switching device 12 includes a vacuum interrupter assembly 50 having a vacuum interrupter 52 provided at a lower location in the switching device 12 and an actuation assembly 54 having a spring mechanism 56 that opens and closes the vacuum interrupter 52 provided at an upper location of the switching device 12, where the vacuum interrupter assembly 50 is representative of any vacuum interrupter assembly known in the art for medium voltage uses that is suitable for the purposes discussed herein. It is noted that in an alternate embodiment, the spring mechanism 56 can be replaced with a magnetic actuator. The actuation assembly 54 includes the various components, electronics, controllers, energy harvesting devices, sensors, communications devices, etc. for operation of the switching device 12. The actuation assembly 54 also includes a dropout mechanism 58 that operates to release the device 12 from the upper coupling assembly 14 that will be described in detail below.

In the known cutout mounted switching devices of the type being described herein, the vacuum interrupter 52 is provided at the top of the device 12 and is coupled to the upper coupling assembly 14, and the actuation assembly 54 is provided at the bottom of the device 12 and is coupled to the lower coupling assembly 16. By placing the actuation assembly 54 at the top of the device 12, the dropout mechanism 58 can be simplified over known designs.

The vacuum interrupter 52 includes an outer insulation housing 70 that provides a vacuum chamber therein that encloses a fixed contact (not shown) connected to a terminal 72 that is electrically coupled to the lower coupling assembly 16 and a movable contact (not shown) that is electrically coupled to a movable terminal 74, where the fixed and movable contacts are in contact with each other within the vacuum chamber when the vacuum interrupter 52 is closed. A bellows 76 allows the movable terminal 74 to move without affecting the vacuum integrity of the vacuum chamber. The movable terminal 74 is coupled to a drive rod 78 in the actuation assembly 54 for opening and closing the vacuum interrupter 52. A conductive strap 80 provides a current path around the spring mechanism 56 from the drive rod 78 to the structure 40. When the vacuum interrupter 52 is opened by moving the movable contact away from the fixed contact the arc that is created between the contacts is extinguished by the vacuum at a zero current crossing.

The actuation assembly 54 includes a current transformer 90 for harvesting energy from the power line and a current sensor (not shown), such as a Rogowski coil, that measures current flow through the switching device 12. The spring mechanism 56 includes an armature or plunger 88 that is typically moved when a solenoid 86 triggers an opening latch mechanism 110 to open the switching device 12 and when the open/close lever 46 triggers a closing latch mechanism 94 to close the vacuum interrupter contacts. In this design, the drive rod 78 is coupled to the plunger 88 and the open/close lever 46 is coupled to the closing latching mechanism 94 to manually open and close the vacuum interrupter 52. The spring mechanism 56 is charged using the charging lever 48. When the switching device 12 is installed, the vacuum interrupter 52 is closed by activating the closing latch mechanism 94 using the open/close lever 46. If fault current is detected, the switch controls send a signal to the solenoid 86, which activates the opening latch mechanism 110 and opens the vacuum interrupter 52. When the closing latch mechanism 94 is activated, a coupler 96 and the moving end of the vacuum interrupter 52 are pushed by an opening spring 98 in the spring mechanism 56 to close the vacuum interrupter 52. When the opening latch mechanism 110 is activated, the plunger 88 is pushed by the spring 98, and the plunger 88 travels a few millimeters before striking the coupler 96 and the moving end of the vacuum interrupter 52, which opens the vacuum interrupter 52.

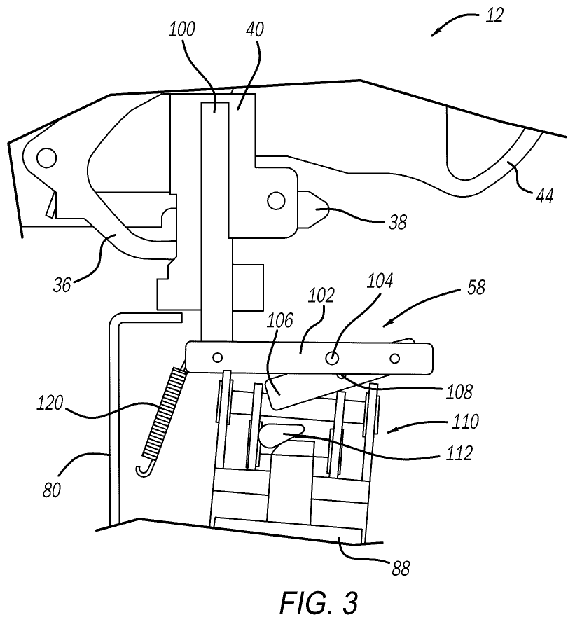

FIG. 3 is a cut-away side view of a top portion of the switching device 12 better illustrating the dropout mechanism 58. The mechanism 58 includes a dropout latch pin 100, a straight lever 102 that pivots on a pivot pin 104 and an angled lever 106 that pivots on a pivot pin 108. The actuation assembly 54 also includes an opening latching mechanism 110 having a toggle unit 112, where the plunger 88 engages the unit 112, and where the charging lever 48 moves the plunger 88 to the charged position, which compresses the spring 98 and resets the opening latch mechanism 110. The pin 100 is coupled at its lower end to one end of the lever 102 and is rigidly coupled to the structure 40. The lever 106 is coupled to the lever 102 opposite to the pin 100. In this configuration, the plunger 88 and the dropout pin 100 are axially offset from each other. When the solenoid 86 is activated it triggers the opening latch mechanism 110, which actuates the plunger 88 in the spring mechanism 56 to open the vacuum interrupter 52. Actuation of the plunger 88 causes the lever 106 to pivot on the pivot pin 108, which pulls down on the end of the lever 102 opposite to the pin 100, which causes the lever 102 to pivot on the pivot pin 104 and raise the dropout pin 100. Moving the pin 100 upward causes the structure 40 to be pushed upward, which causes it to be released from the upper coupling assembly 14, and which causes the switching device 12 to rotate on the trunnion rod 28. A return spring 120 is coupled to the same end of the lever 102 as the pin 100 and the housing 22, and maintains the lever 102 in the charged position when the vacuum interrupter 52 is closed.

When the switching device 12 is installed, the vacuum interrupter 52 is in the open position. The trunnion rod 28 is placed in the hinge 26 and a hotstick is used to grab the ring 44 and swing the device 12 upward so that the structure 40 engages the upper coupling assembly 14. The hotstick is then used to pull down the charging lever 48 to mechanically charge the opening spring 98 in the spring mechanism 56, which will not close the vacuum interrupter contacts. When the hotstick is removed, the charging lever 48 automatically toggles to the neutral position. The hotstick is then used to actuate the open/close lever 46 to manually activate the opening latching mechanism 110, which causes the opening spring 98 to close the vacuum interrupter 52. Some of the energy in the opening spring 98 will be consumed, but there is still enough energy to perform an open operation. After the hotstick is removed from the open/close lever 46, the lever 46 will automatically toggle to the neutral position.

When a fault or overcurrent is detected, an open command is sent to the solenoid 86 and the opening latch mechanism 110 is activated, where the current transformer 90 harvests energy to perform the operation. Activation of the opening latch mechanism 110 allows the opening spring 98 to release its remaining stored energy to move the plunger 88, which results in the opening of the vacuum interrupter 52. After a few millimeters of travel, the plunger 88 pulls the moving contact away from the fixed contact and causes the vacuum interrupter 52 to open. At this point, the plunger 88 continues to travel until it reaches an uncharged/rest position. The dropout mechanism 58 only uses the last part of the plunger motion to activate the drop out operation. The last part of the plunger motion is transferred to the off-center levers 102 and 106 to get the deflection/force needed to release the switching device 12 from the upper coupling assembly 14. The relatively small motion of the plunger 88 is transferred into a larger motion by the levers 102 and 106. By using just the last part of the plunger travel, the dropout mechanism 58 will give the desired “delay” between the spring mechanism 56 opening the vacuum interrupter 52 and the actual “dropout” of the device 12 from the upper coupling assembly 14. The return spring 120 ensures that the dropout latch pin 100 is in the ready-to-unlatch position before the switching device 12 is swung into the upper coupling assembly 14.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A cutout mounted switching device configured to be coupled to cutout including an upper coupling assembly and a lower coupling assembly, the cutout being mounted on a utility pole, the switching device comprising:
a switch including an upper end and a lower end, the lower end of the switch being electrically coupled to the lower coupling assembly; and
an actuation assembly including an upper end and a lower end, the lower end of the actuation assembly being electrically coupled to the upper end of the switch and the upper end of the actuation assembly being electrically coupled to the upper coupling assembly, the actuation assembly being configured to open and close the switch and cause the switching device to be released from the upper coupling assembly and rotate to a drop out position on the lower coupling assembly.

2. The switching device according to claim 1 wherein the switch is a vacuum interrupter including a fixed terminal and a movable terminal, the fixed terminal being coupled to the lower coupling assembly and the movable terminal being coupled to a drive rod in the actuation assembly.

3. The switching device according to claim 2 wherein the actuation assembly includes a spring mechanism having a solenoid and a plunger, the plunger being coupled to the drive rod.

4. The switching device according to claim 3 wherein the actuation assembly further includes a dropout mechanism having a dropout pin, the dropout mechanism being coupled to the plunger and the dropout pin being coupled to a switch structure that is releasably coupled to the upper coupling assembly, and wherein the plunger and the dropout pin are axially offset relative to each other.

5. The switching device according to claim 4 wherein the dropout mechanism further includes a first lever having a first end and a second end and being pivotable on a first pivot pin and a second lever having a first end and a second end and being pivotable on a second pivot pin, the first end of the first lever being coupled to the plunger, the second end of the first lever being coupled to the first end of the second lever and the second end of the second lever being coupled to the dropout pin, and wherein actuation of the spring mechanism to open the vacuum interrupter causes the plunger to move upward and pivot the first lever on the first pivot pin, which causes the second lever to pivot on the second pivot pin, which causes the dropout pin to move upward, which causes the switch structure to be released from the upper coupling assembly.

6. The switching device according to claim 5 wherein the actuation assembly further includes a latching mechanism that couples the plunger to the first lever.

7. The switching device according to claim 6 further comprising a charging lever coupled to the latching mechanism that allows manual charging of the spring mechanism.

8. The switching device according to claim 5 wherein the second end of the second lever is coupled to a return spring that holds the second lever in place when the vacuum interrupter is closed.

9. The switching device according to claim 3 further comprising an open/close lever for manually opening or closing the vacuum interrupter.

10. A cutout mounted switching device configured to be coupled to a cutout including a first coupling assembly and a second coupling assembly, the switching device comprising:
a vacuum interrupter including a fixed terminal and a movable terminal, the fixed terminal being electrically coupled to the first coupling assembly and the movable terminal being electrically coupled to a drive rod; and
an actuation assembly including a spring mechanism having a solenoid and a plunger, the plunger being coupled to the drive rod, the actuation assembly further including a dropout mechanism having a dropout pin, the dropout mechanism being coupled to the plunger and the dropout pin being coupled to a switch structure that is releasably coupled to the second coupling assembly, wherein the plunger and the dropout pin are axially offset relative to each other, the actuation assembly being configured to open and close the vacuum interrupter and cause the switching device to be released from the second coupling assembly and rotate to a drop out position on the first coupling assembly.

11. The switching device according to claim 10 wherein the dropout mechanism further includes a first lever having a first end and a second end and being pivotable on a first pivot pin and a second lever having a first end and a second end and being pivotable on a second pivot pin, the first end of the first lever being coupled to the plunger, the second end of the first lever being coupled to the first end of the second lever and the second end of the second lever being coupled to the dropout pin, and wherein actuation of the spring mechanism to open the vacuum interrupter causes the plunger to move upward and pivot the first lever on the first pivot pin, which causes the second lever to pivot on the second pivot pin, which causes the dropout pin to move upward, which causes the switch structure to be released from the second coupling assembly.

12. The switching device according to claim 11 wherein the actuation assembly further includes a latching mechanism that couples the plunger to the first lever.

13. The switching device according to claim 12 further comprising a charging lever coupled to the latching mechanism that allows manual charging of the spring mechanism.

14. The switching device according to claim 12 wherein the second end of the second lever is coupled to a return spring that holds the second lever in place when the vacuum interrupter is closed.

15. The switching device according to claim 10 further comprising an open/close lever for manually opening or closing the vacuum interrupter.

16. The switching device according to claim 10 wherein the first coupling assembly is a lower coupling assembly on a utility pole and the second coupling assembly is an upper coupling assembly on the utility pole.

17. A cutout mounted switching device configured to be coupled to an upper coupling assembly and a lower coupling assembly on a utility pole, the switching device comprising:
a vacuum interrupter including a fixed terminal and a movable terminal, the fixed terminal being coupled to the lower coupling assembly and the movable terminal being electrically coupled to a drive rod; and
an actuation assembly coupled to the drive rod, the actuation assembly including a dropout mechanism having a dropout pin, the dropout pin being coupled to a switch structure that is releasably coupled to the upper coupling assembly, the actuation assembly being configured to open and close the vacuum interrupter and cause the switching device to be released from the upper coupling assembly and rotate to a drop out position on the lower coupling assembly.

18. The switching device according to claim 17 wherein the dropout mechanism further includes a first lever having a first end and a second end and being pivotable on a first pivot pin and a second lever having a first end and a second end and being pivotable on a second pivot pin, the first end of the first lever being coupled to the actuation assembly, the second end of the first lever being coupled to the first end of the second lever and the second end of the second lever being coupled to the dropout pin, and wherein actuation of the actuation assembly to open the vacuum interrupter causes the first lever to pivot on the first pivot pin, which causes the second lever to pivot on the second pivot pin, which causes the dropout pin to move upward, which causes the switch structure to be released from the upper coupling assembly.

19. The switching device according to claim 18 wherein the actuation assembly further includes a latching mechanism that couples the actuation assembly to the first lever.

20. The switching device according to claim 18 wherein the second end of the second lever is coupled to a return spring that holds the second lever in place when the vacuum interrupter is closed.
